(19) United States
(12) Patent Application Publication
(10) Pub. No.: US 2012/0084949 A1
(43) Pub. Date: Apr. 12, 2012

(54) Adjustable Table Clip

(76) Inventor: Akeel Al-Basri, Prestwich (GB)

(21) Appl. No.: 12/898,730

(22) Filed: Oct. 6, 2010

(51) Int. Cl. F16B 2/20

(52) U.S. Cl. 24/457

(57) ABSTRACT

This invention relates to a new device designed specifically for clipping table covers or any other material or object to different thicknesses of table tops. The device is an Adjustable Table Clip and the user can adjust it to accommodate the table thickness.

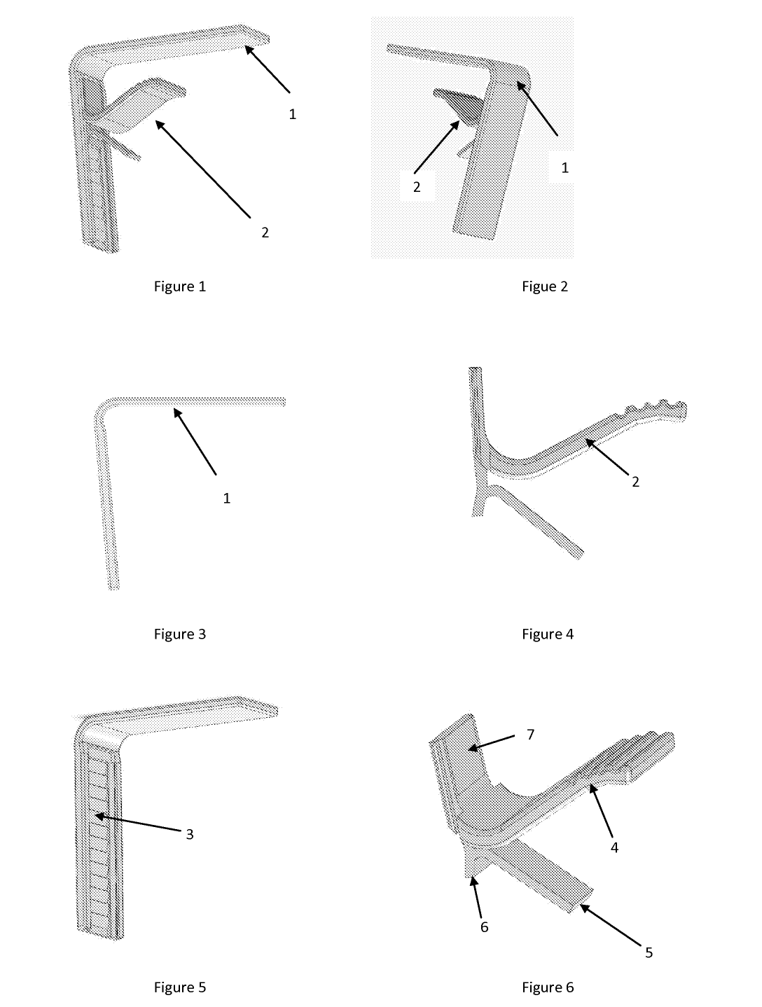

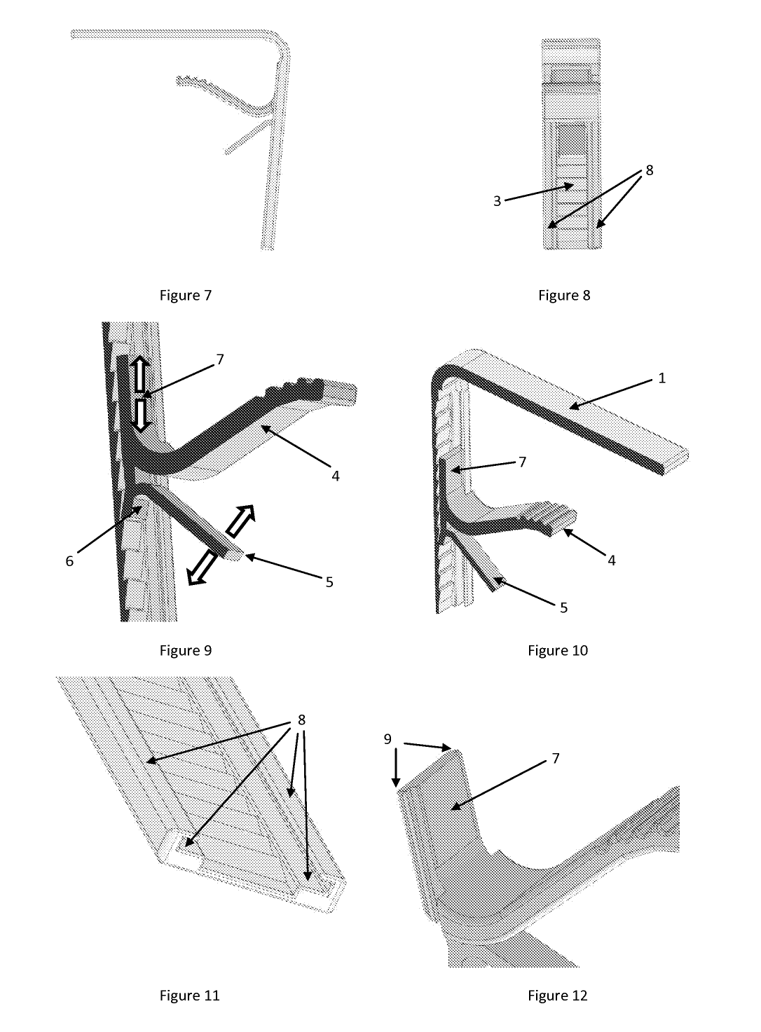

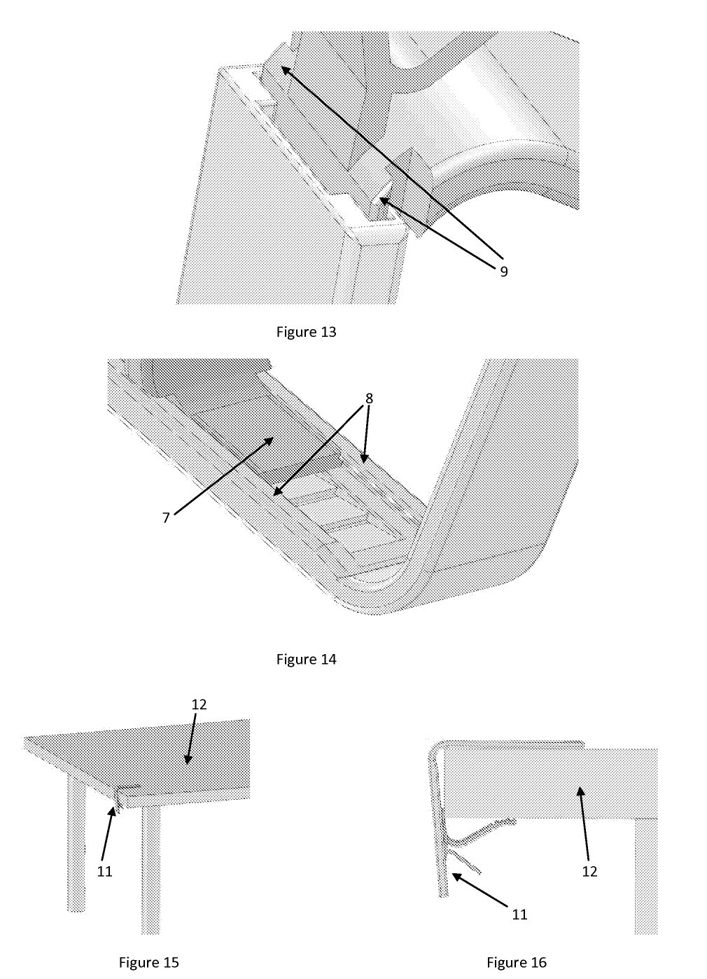

The adjustable Table Clip invention is to give the user the ability to adjust the table clip to a different size jaw, to accommodate for the thickness of the table top it is being clipped to. The invention and advantage of this device is to give a tight grip on the table top for any width of jaw. The other side of the invention is the methodology and mechanism of the adjustment of the jaw size and the secure locking of the jaw.

### BACKGROUND

This invention relates to a new device designed specifically for clipping table cloths to different thicknesses of table tops. The device is an Adjustable Table Clip and the user can adjust it to accommodate the table thickness.

### STATEMENT OF INVENTION

The adjustable Table Clip invention is to give the user the ability to adjust the table clip to a different size jaw, to accommodate for the thickness of the table top it is being clipped to. The invention and advantage of this device is to give a tight grip on the table top for any width of jaw. The other side of the invention is the methodology and mechanism of the adjustment of the jaw size and the secure locking of the jaw.

### ADVANTAGES

The Adjustable Table Clip invention is to solve the problem of having a variety of different table clips to be clipped on table tops of different thicknesses. The Adjustable Table Clip can be used for most table top thicknesses. The advantages of the Adjustable Table Clip is to give a tight grip on the table top for any jaw width where the tightness of the grip is consistent whatever the size of the table top thickness and suitable for table skirting attachments by sticking Velcro on the table clip and for other uses of clipping tablecloths on a variety of table top thicknesses.

### SPECIFICATION

The Adjustable Table Clip is specifically designed for clipping tablecloths on table tops of different thicknesses. The Adjustable table clip assembly comprises two parts; the top jaw and lower jaw. The top jaw is an L shaped part functioning as a jaw to meet the lower jaw part and the top jaw part consists of tracks on the sides to host the lower jaw part and has a chamfered steps designed to trap the lower jaw part in a fixed position. The lower jaw part consists of 4 extensions; the jaw gripper extension, the lever extension, the wedge extension and the sliding skate extension. The lower jaw part is designed to slide through the sliding skate section. The skate section has a further wing extension to secure the sliding skate to the top jaw part and when the user pushes the lower jaw part upwards through the track end the lower jaw part will slide through with some friction on the chamfered steps. As every chamfered step is passed the wedge extension will prevent the lower jaw part from sliding downward as the wedge extension will be trapped against the lower chamfered step. This functionality will secure the lower jaw part in one position when it is gripping the table top. If the user needs to slide the lower jaw part downward to a different position, the lever extension needs to be pushed towards the jaw gripper extension. This action will result in bending the wedge extension away from the chamfered step and will be released from the trapped position. By keeping the pressure applied on the lever extension the user can continue moving the lower jaw part downward to any desired position required and in order to lock this desired position the user needs to release the lever extension resulting in the wedge extension movement against the lower chamfered step securing the position of the lower jaw part. The user can slide the lower jaw part completely out of the top jaw part if needed. When the user selects a suitable position for clipping a table top, the Adjustable Table Clip can be slid onto the edge of the table. The pressure of the gripping from the top and lower jaw parts will create further security on the wedge extension which will be forced and trapped further between the chamfered steps preventing the lower jaw part from sliding downward.

1. An adjustable table clip assembly comprising first and second jaws adapted for relative movement, the first jaw part comprising an L-shaped upper portion and the lower jaw part being configured to be vertically adjustable in use relative to the upper jaw part, one of the jaw parts being provided with tracks/channels and chamfered steps and the other jaw part being profiled to be mounted within the tracks or channels and having a wedge extension that engages with the chamfered steps and which is moved out of engagement with the chamfered steps by a lever extension.

2. An adjustable clip assembly according to claim 1 where the tracks/channels and chamfered steps are provided on the upper jaw part and the wedge extension and lever extension are provided on the lower jaw part.

3. An adjustable clip assembly according to claim 1 where the tracks/channels and chamfered steps are provided on the lower jaw part and the wedge extension and lever extension are provided on the upper jaw part.

4. An adjustable clip assembly according to claim 1 or 2 where chamfered steps are provided on the back or sides of the upper jaw part.

5. An adjustable clip assembly according to any preceding claim where the assembly is made from plastic material.
